(19) United States
(12) Patent Application Publication
(10) Pub. No.: US 2004/0083149 A1
(43) Pub. Date: Apr. 29, 2004

(54) Multiple stage currency processing system

(76) Inventor: William J. Jones, Barrington, IL (US)

Correspondence Address: JENKENS & GILCHRIST, P.C., 225 WEST WASHINGTON, SUITE 2600, CHICAGO, IL, 60606, US

(21) Appl. No.: 10/689,302

(22) Filed: Oct. 20, 2003

Related U.S. Application Data
(60) Provisional application No. 60/420,844, filed on Oct. 24, 2002.

(51) Int. Cl. G06F 17/60

(52) U.S. Cl. 705/35

(57) ABSTRACT

According to one embodiment of the present invention, a currency processing system includes three currency processing stages. The first currency processing stage includes a plurality of compact currency handling devices for denominating and counting currency bills. The second currency processing stage includes a high-capacity currency handling device for denominating, counting, and sorting currency bills. The third currency processing stage includes a plurality of compact currency handling devices for counting currency bills. A controller is operatively coupled with the first, second, and third currency processing stages for receiving and comparing information related to the counting of currency at each currency processing stage.

### CROSS REFERENCE TO RELATED APPLICATIONS

This application claims the benefit of U.S. Provisional Patent Application Ser. No. 60/420,844, entitled “Multiple Stage Currency Processing System,” which was filed on Oct. 24, 2002 and is incorporated herein by reference in its entirety.

### FIELD OF THE INVENTION

The present invention relates generally to the field of currency handling systems and, more particularly, to a multiple stage currency handling system for discriminating, counting, sorting, authenticating, and/or otherwise processing currency bills.

### BACKGROUND OF THE INVENTION

A variety of techniques and apparatuses have been used to satisfy the requirements of automated currency processing. As the number of businesses that deal with large quantities of paper currency grow, such as banks, casinos, and armored carriers, these businesses are continually requiring not only that their currency be processed more quickly but, also, processed with greater accuracy and with more efficiency.

Typically these business use currency processing devices to count, denominate, authenticate, sort, and/or otherwise process currency bills. These devices include single output receptacle, double output receptacle, and multiple output receptacle devices. At the upper end of sophistication in this area of technology are devices that are capable of processing high volumes of currency. These high volume currency handling devices are able to rapidly identify, discriminate, and count multiple currency denominations and then sort currency bills into a number of output receptacles. At the lower end of sophistication in this area of technology are compact, table-top devices that are capable of identifying, discriminating, and counting multiple currency denominations. These table-top devices may contain one, two, three, or several output receptacles.

Commonly, in the processing of currency at a bank, for example, cash deposits are first received and verified by a bank teller. The cash deposit is later sorted according to denomination. Finally, the sorted bills are bundled or strapped in stacks of a predetermined number of bills (often one hundred bills).

Often the teller that receives the cash deposit manually counts the cash deposit, manually records the deposited amount, or both. One problem associated with these manual procedures is that room for human error exists. Further, manually counting and recording cash deposits is an inefficient process especially when larger quantities of currency bills are involved.

### SUMMARY OF THE INVENTION

According to one embodiment of the present invention, a currency processing system includes three currency processing stages. The first currency processing stage includes a plurality of compact currency handling devices for denominating and counting currency bills. The second currency processing stage includes a high-capacity currency handling device for denominating, counting, and sorting currency bills. The third currency processing stage includes a plurality of compact currency handling devices for counting currency bills. A controller is operatively coupled with the first, second, and third currency processing stage devices for receiving and comparing information related to the counting of currency at each currency processing stage.

The above summary of the present invention is not intended to represent each embodiment, or every aspect, of the present invention. Additional features and benefits of the present invention will become apparent from the detailed description, figures, and claims set forth below.

### BRIEF DESCRIPTION OF THE DRAWINGS

FIG. 1 is a functional block diagram illustrating a multiple stage currency processing system according to one embodiment of the present invention.

FIG. 2 is a perspective view of a currency processing device having one output receptacle for use with the system of FIG. 1.

FIG. 3 is a functional block diagram of the device of FIG. 2.

FIG. 4 is a perspective view of a currency processing device having two output receptacles for use with the system of FIG. 1.

FIG. 5a is a front view of a currency processing device having multiple output receptacles for use with the system of FIG. 1.

FIG. 5b is a functional illustration of a currency processing device having multiple output receptacles with a strapping unit for use with the system of FIG. 1, according to an alternative embodiment of the present invention.

FIG. 6 is a block diagram illustrating a multiple stage currency processing system according to one embodiment of the present invention.

FIG. 7 is a block diagram illustrating a multiple stage currency processing system according to an alternative embodiment of the present invention.

FIG. 8 is a block diagram illustrating a multiple stage currency processing system according to another alternative embodiment of the present invention

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

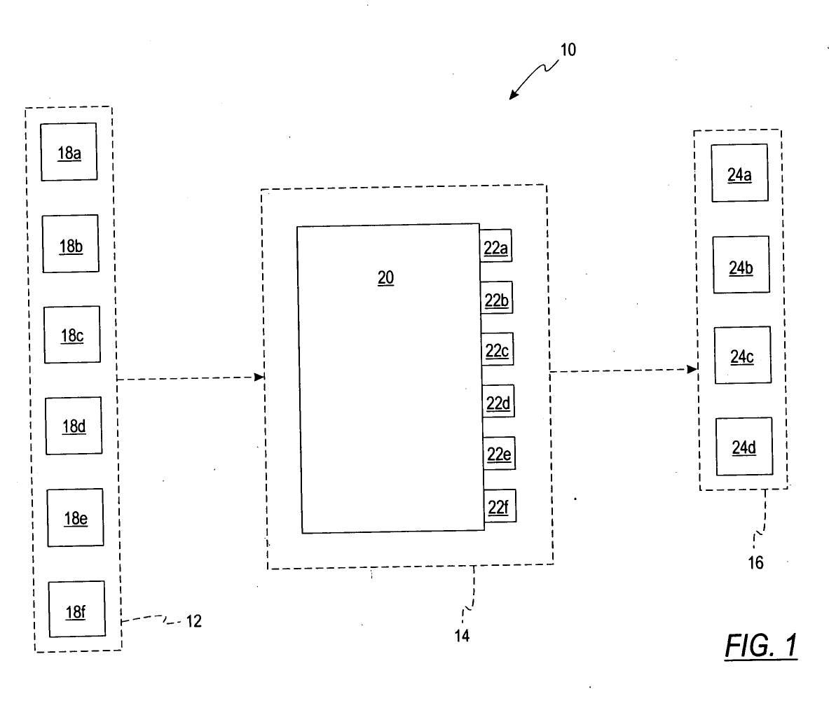

Referring to the drawings and initially to FIG. 1, a block diagram illustrating a multiple stage currency processing system 10 (“multi-stage system 10”) is shown according to one embodiment of the present invention. The illustrated embodiment of the multi-stage system 10 includes a first stage generally represented by dashed line 12, a second stage generally represented by dashed line 14, and a third stage generally represented by dashed line 16. Each of the currency processing stages 12, 14, 16 include one or more currency processing devices, which are described in greater detail below. The currency processing devices of the first, second, and third stages may be located in generally the same physical location (e.g., in a bank) or are physically separated (e.g., among several bank branches) according to various alternative embodiments of the multi-stage system 10.

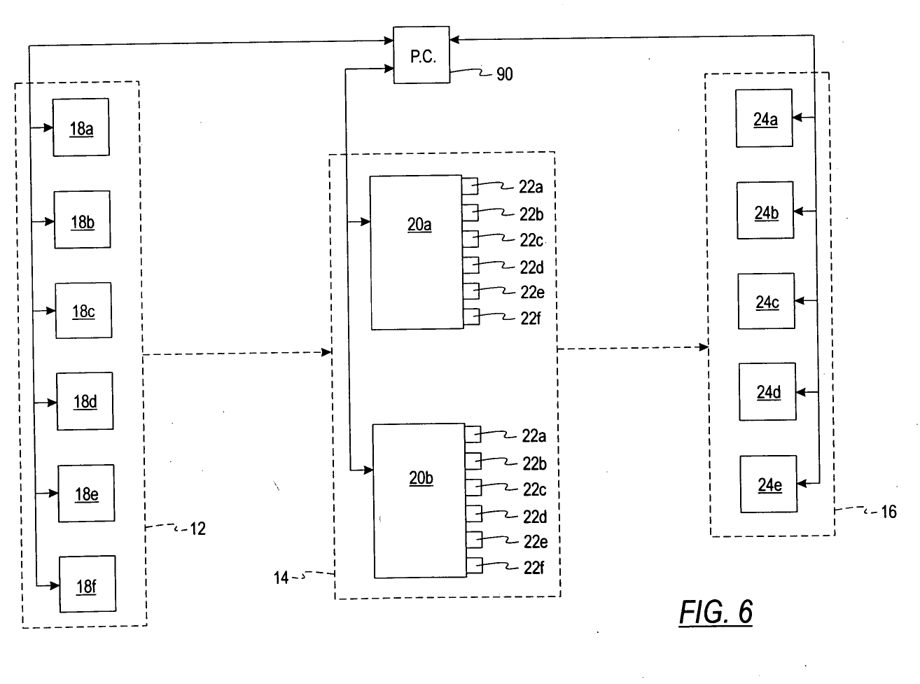

Generally, according to one embodiment of the multi-stage system 10, the first currency processing stage 12 is comprised of a plurality of tabletop-type currency processing devices 18a-f for counting currency bills received in the first currency processing stage 12. The second currency processing stage 14 receives currency bills from the first stage 12 and is comprised of one or more currency processing devices 20 having a plurality of output receptacles 22a-f for sorting bills by denomination. According to an alternative embodiment of the multi-stage system 10, the second stage currency processing devices 20 may having the capability to automatically strap the currency bills as is described in further detail below. Finally, the third currency processing stage 16 receives currency bills from the second stage 14 and is comprised of one or more tabletop-type currency processing devices 24a-d for use in a bill strapping operation, wherein the one or more third stage devices 24 output a predetermined number of currency bills of a single denomination and then suspend operation while the operator straps those bills as is described in greater detail below. The third stage devices 24 verifies the denomination of each of the currency bills or simply counts the currency bills, as is further described below, according to alternative embodiments of the present invention. Further, some of the third stage devices can employ automatic strapping, as is further described below, according to one embodiment of the present inventions. In some embodiments of the multi-stage system 10, the currency processing devices 18, 20, and 24 of the first 12, second 14, and third 16 stages are networked to a central computer 90 (FIG. 6) for comparing the totals determined at the different currency processing stages. Such comparisons improve the overall integrity of the currency handling process.

According to one embodiment of the multi-stage system 10, the first and third stage currency processing devices 18, 24 include devices having a single output receptacle (“single-pocket device”). Examples of single-pockets devices are disclosed in U.S. Pat. Nos. 5,790,697 and 5,704,491, each of which is incorporated herein by reference in its entirety. In other embodiments of the multi-stage system 10, the first and third stage currency processing devices 18, 24 include devices having two output receptacles (“two-pocket device”). Examples of two-pocket devices are disclosed in U.S. Pat. Nos. 5,966,456; 6,278,795; and 6,311,819; each of which is incorporated herein by reference in its entirety. U.S. Pat. Nos. 5,966,456 and 6,278,795 also disclose tabletop-type two-pocket devices that can be utilized in the first and third currency processing stages 12, 16 according to various alternative embodiments of multi-stage system 10. While the first and third stages 12, 16 have been described in connection with tabletop-type currency processing devices, other types of currency processing devices, such as floor standing currency processing devices, are used in various alternative embodiments of the present invention. According to an alternative embodiment of the present invention, the first and third 12, 16 currency processing stages include devices capable of automatically strapping currency bills.

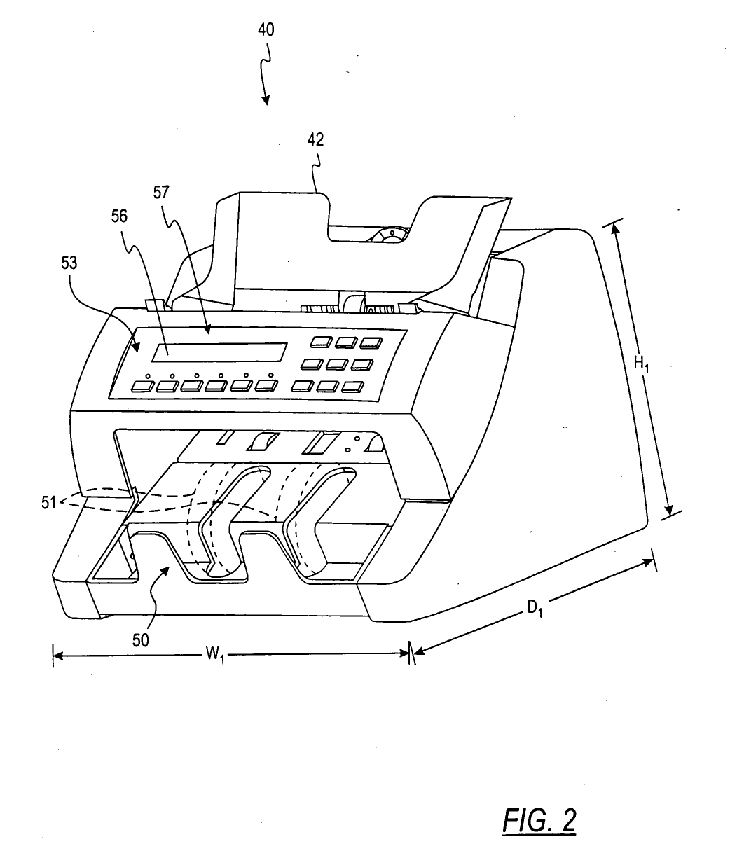

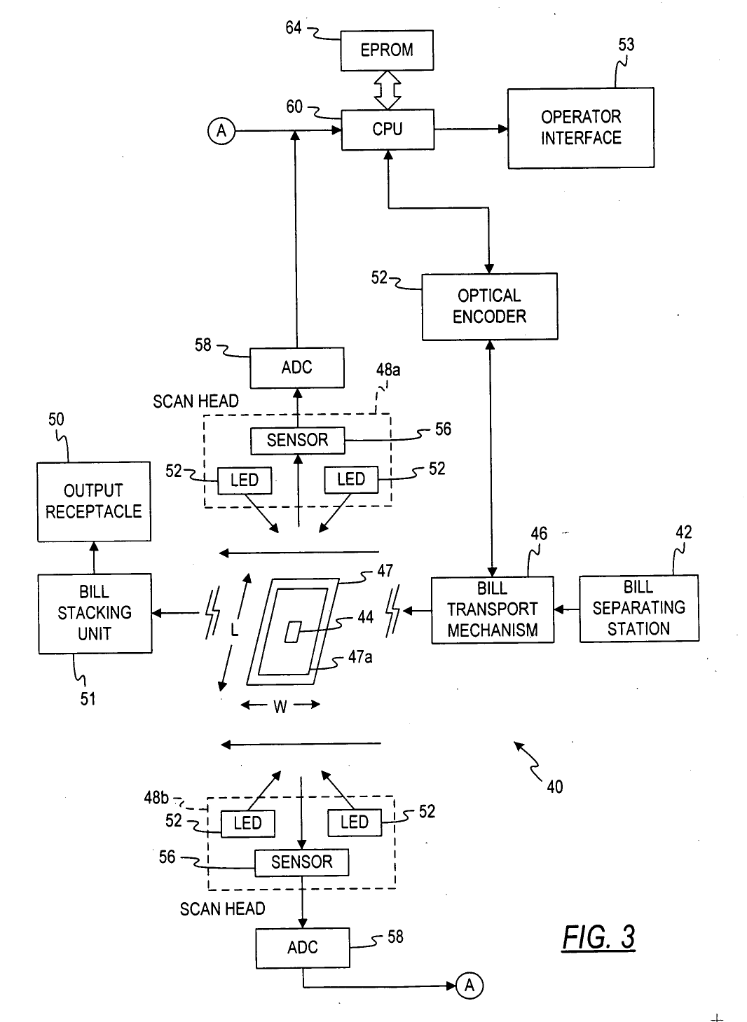

Referring now to FIGS. 2 and 3, there is shown a single-pocket device 40. Using a single-pocket device as an example, the operation of the currency handling devices of the first and third stages 12, 16 will be described in detail. The single-pocket device 40 includes an input receptacle 42 for receiving a stack of currency bills to be processed (e.g., counted, denominated, authenticated, etc.). Currency bills in the input receptacle 42 are picked out or separated, one bill at a time, and sequentially relayed by a bill transport mechanism 46, between a pair of scanheads 48a and 48b where, for example, the currency denomination of each bill is scanned and identified. In the illustrated embodiment, each scanhead 48 is an optical scanhead that scans for optical characteristic information from a scanned bill 47 that is used to identify the denomination of the bill 47. The scanned bill 47 is then transported to an output receptacle 50, which may include a pair of stacking wheels 51, where processed bills are stacked for subsequent removal. The device 40 includes an operator interface 53 with a display 56 for communicating information to an operator of the device 40, and buttons 57 for receiving operator input.

In alternative embodiments of the present invention, additional sensors replace or are used in conjunction with the optical scanheads 48a,b in the device 40 to analyze, authenticate, denominate, count, and/or otherwise process currency bills. For example, size detection sensors, magnetic sensors, thread sensors, and/or ultraviolet/fluorescent light sensors may be used in the currency processing device 40 to evaluate currency bills. Uses of these types of sensors for currency evaluation are described in U.S. Pat. No. 6,279,795, which is incorporated herein by reference in its entirety.

According to one embodiment of the currency processing device 40, each optical scanhead 48a,b comprises a pair of light sources 52, such as light emitting diodes (LEDs), that direct light onto the bill transport path so as to illuminate a substantially rectangular light strip 44 upon a currency bill 47 positioned on the transport path adjacent the scanhead 48. Light reflected off the illuminated strip 44 is sensed by an optical detector 56 (e.g., a photodetector) positioned between the two light sources. The analog output of the optical detector 56 is converted into a digital signal by means of an analog-to-digital convertor (ADC) 58 whose output is fed as a digital input to a processor such as central processing unit (CPU) 60.

According to one embodiment, the bill transport path is defined in such a way that the transport mechanism 46 moves currency bills with the narrow dimension of the bills parallel to the transport path and the scan direction. As a bill 47 traverses the scanheads 48, the light strip 44 effectively scans the bill across the narrow dimension of the bill 47. In the depicted embodiment, the transport path is arranged so that a currency bill 47 is scanned across a central section of the bill along its narrow dimension, as shown in FIG. 3. Each scanhead functions to detect light reflected from the bill 47 as it moves across the illuminated light strip 44 and to provide an analog representation of the variation in reflected light, which, in turn, represents the variation in the dark and light content of the printed pattern or indicia on the surface of the bill 47. This variation in light reflected from the narrow dimension scanning of the bills serves as a measure for distinguishing, with a high degree of confidence, among a number of currency denominations that the system is programmed to process.

Additional details of the operational and mechanical aspects of the device 40 illustrated in FIGS. 2 and 3 are described in U.S. Pat. Nos. 5,295,196 and 5,815,592, each of which is incorporated herein by reference in its entirety. According to various alternative embodiments, the currency processing device 40 is capable of processing, including denominating the bills, from about 600 to over 1500 bills per minute.

While the single-pocket device 40 of FIGS. 2 and 3 has been described as a device capable of determining the denomination of processed bill, the multi-stage system 10 utilizes note counting devices according to alternative embodiments of the present invention. Particularly, note counting devices may be used in the third currency processing stage 16 where currency bills of a single denomination are processed at one time according to one embodiment of the present invention as is described in further detail below. Note counting devices are disclosed in U.S. Pat. Nos. 6,026,175 and 6,012,565 and in U.S. patent application Ser. No. 09/611,279, filed Jul. 6, 2000, each of which is incorporated herein by reference in its entirety. Note counting devices differ from currency denominating devices in that note counting devices do not denominate the currency bills being processed and are not designed to process and determine the total value of a stack of mixed denomination currency bills.

As indicated above, according to one embodiment of the present invention, the single-pocket device 40 of FIG. 2 is compact and designed to be rested on a tabletop. The device 40 of FIG. 2 has a height (H₁) of about 9.5 inches (about 24.14 cm), a width (W₁) of about 11-15 inches (about 27.94-38.10 cm), and a depth (D₁) of about 12-16 inches (about 30.48-40.64 cm), which corresponds to a footprint ranging from about 132 in² (about 851 cm²) to about 250 in² (about 1613 cm²) and a volume ranging from about 1254 in³ (about 20,549 cm³) to about 2280 in³ (about 37,363 cm³).

As discussed above, the first and third stage currency processing stages 12, 16 (FIG. 1) may include currency processing devices having more than one output receptacle according to various alternative embodiments of the multi-stage system 10. For example, the first or third currency processing stages 12, 16 of the present invention may include a device having two, four, or six output receptacles or may include a combination of single-pocket devices and devices having multiple output receptacles.

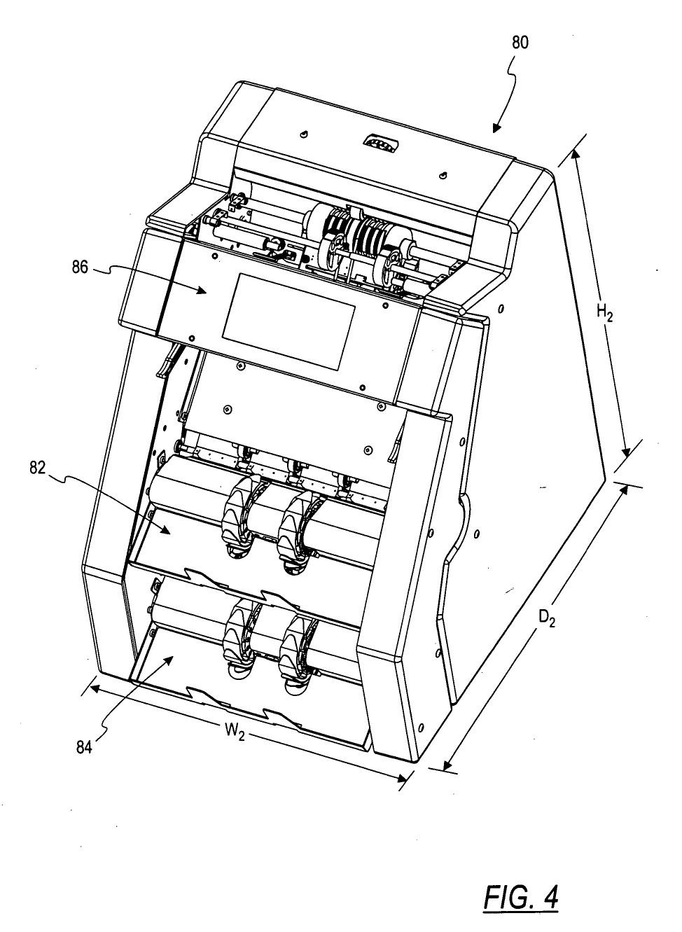

Referring now to FIG. 4, a currency processing device 80 having two output receptacles (“two-pocket device”)—a first output receptacle 82 and a second output receptacle 84—for implementation in the first and third stages 12, 16 of the multi-stage system 10 is shown. The two-pocket device 80 includes an operator interface 86 for communicating with an operator of the device 80. Generally, the two-pocket device 80 (FIG. 4) operates in a similar manner to that of the single-pocket device 40 (FIG. 2), except that the transport mechanism of the two-pocket device 80 transports the bills to either of the two output receptacles 82, 84. The two output receptacles 82, 84 may be utilized in a variety of fashions according to various applications. For example, in the processing of currency bills, the bills may be directed to the first output receptacle 82 until a predetermined number of bills have been transported to the first output receptacle 82 (e.g., until the first output receptacle 82 reaches capacity or a strap limit) and then directs subsequent bills to the second output receptacle 84. In another application, all bills are transported to the first output receptacle 82 expect those bills triggering error signals such as, for example, “no call” error signals (i.e., bill whose denomination is not identified) and “suspect document” error signals (i.e., bills failing an authentication test). Those bills triggering error signals are directed to the second output receptacle 84. Further details of the operational and mechanical aspects of the two-pocket device 80 illustrated in FIG. 4 are detailed in U.S. Pat. Nos. 5,966,546; 6,278,795; and 6,311,819; each of which is incorporated herein by reference in its entirety.

While in some applications it is desirable to have a second output receptacle for which to routed rejected bills, in other applications a two-pocket device 80 may be used to off-sort “desired bills.” For example, in one application, a bank may desire to off-sort $10 bills and/or $20 bills for use in an Automatic Teller Machine (ATM).

According to alternative embodiments of the multi-stage system 10, the currency processing devices 18, 22, 24 at the three currency processing stages 12, 14, 16 are capable of processing other documents including casino script or other “substitute currency media” in addition to currency bills. Examples of “substitute currency media” include casino cashout tickets (also referred to as “cashout vouchers” or “coupons”) such as “EZ Pay” tickets issued by International Gaming Technology or “Quicket” tickets issued by Casino Data Systems; casino script; promotional media such as Disney Dollars or Toys 'R Us “Geoffrey Dollars”; or retailer coupons, gift certificates, gift cards, or food stamps. The processing of substitute currency media is described in U.S. patent application Publication No. 2002-0020603-A1, entitled “System And Method for Processing Currency Bills and Substitute Currency Media in a Single Device” and filed Sep. 28, 2001, which is incorporated herein by reference in its entirety. Devices capable of processing casino cashout tickets and cash are useful in a casino environment. For example, according to one embodiment, the currency processing device 22 at the second stage 12 processes casino cashout tickets and currency and sorts them from each other. In another embodiment, the first stage devices 18 are devices having two or more pockets, such as the two-pocket device 80, that separate the currency bills from the casino cashout tickets (e.g., bills are directed to the first pocket 82 and casino cashout tickets are directed to the second pocket 84).

According to alternative embodiments of the multi-stage system 10, the currency processing devices 18, 22, 24 at the three currency processing stages 12, 14, 16 are capable of processing both checks and currency. Such an embodiment would be useful in a banking application where both checks and currency bills are commonplace. According to one embodiment of the present invention, the first stage device may process the currency bills as described as well as process the checks by, for example, imaging the checks. The images of the checks are then transmitted to the bank's proofing department for proof-of-deposit processing as is known in the art. In an embodiment wherein the first stage device is a two-pocket device 80, the first stage device sorts the checks into one of the two output receptacles and sorts the currency bills into the other of the two output receptacles.

According to one embodiment of the present invention, the two-pocket device 80 illustrated in FIG. 4 is compact having a height (H₂) of about 17.5 inches (about 44.5 cm), a width (W₂) of about 13.5 inches (about 34.3 cm), and a depth (D₂) of about 15 inches (about 38.1 cm), and weighs approximately 35 lbs. (about 16 kg). The two-pocket device 80 is compact and is designed to be rested upon a tabletop. The two-pocket device 80 has a footprint of about 202.5 in² (about 1307 cm²) and occupies a volume of about 3544 in³ (about 58,154 cm³).

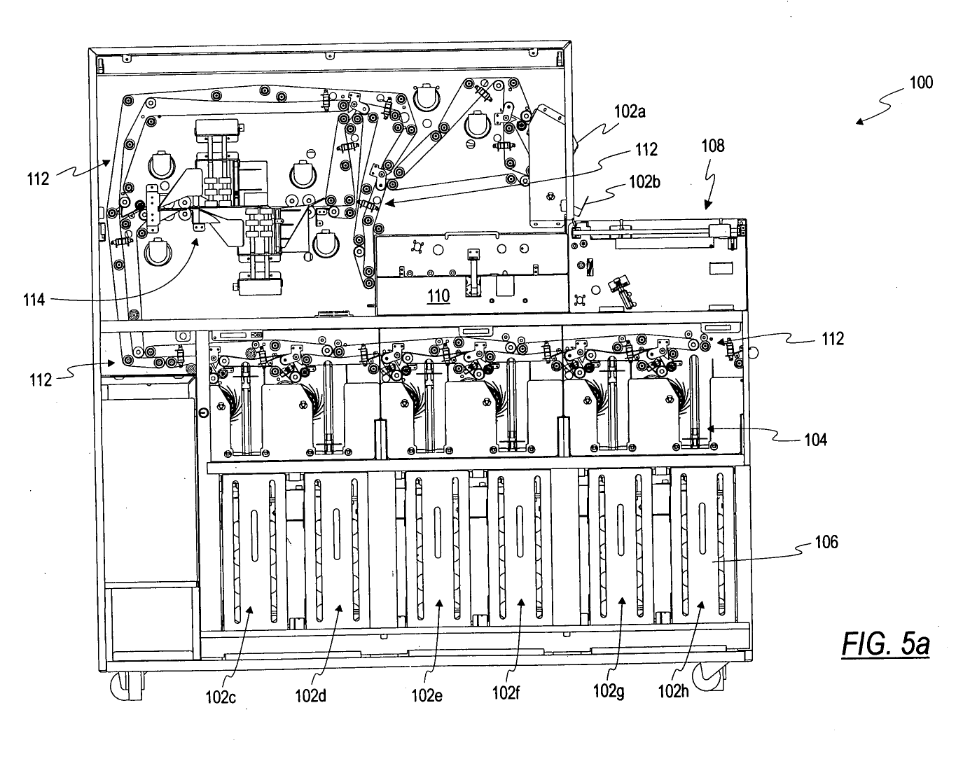

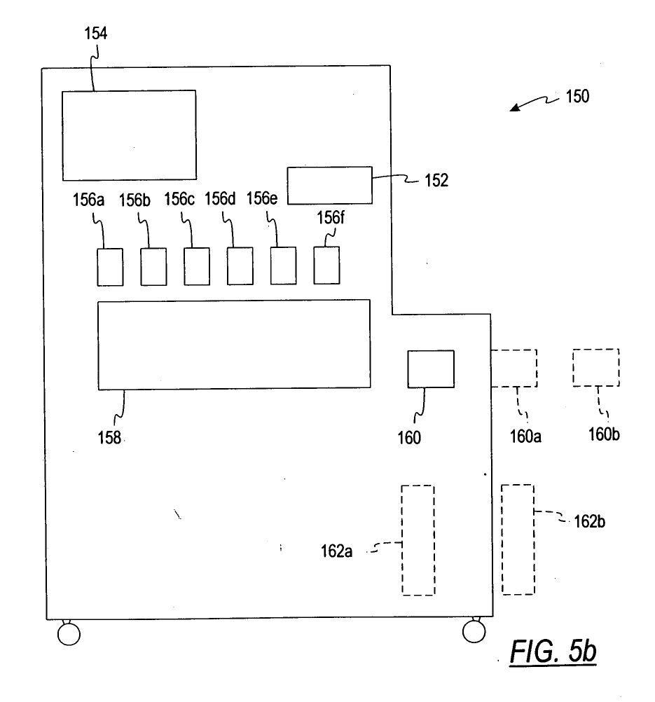

Referring now to FIG. 5a, there is shown a currency processing device 100 having a plurality of output receptacles 102a-h (hereinafter “MPS” for multi-pocket sorter) that is implemented in the second currency processing stage 12 according to one embodiment of the multi-stage system 10 (FIG. 1). According to alternative embodiments of the multi-stage system 10, one or more MPSs 100 are implemented in the second stage 12. The MPS 100 illustrated in FIG. 5a includes eight output receptacles 102a-h: two upper output receptacles 102a,b and six lower output receptacles 102c-h. Further, modular lower output receptacles (not shown) may be added to the MPS 100 to increase the number of lower output receptacles. Each of the lower output receptacles 102c-h includes an escrow region 104 (shown with respect to the sixth lower output receptacle 102h) for receiving and stacking currency bills and a storage cassette 106 for holding stacks of processed currency bills. Currency bills transported to a particular one of the escrow regions 104 and are stacked therein. At specified times or on the occurrence of specific events, currency bills stacked in an escrow region 104 are moved into the corresponding storage cassette 106. According to one embodiment, each storage cassette 106 has a capacity of about one thousand currency bills.

According to an alternative embodiment of the present invention, one or more table-top versions of the MPS 100 shown in FIG. 5a may be implemented in the second currency processing stage 12. Generally, a table-top version of the MPS operates in a manner similar to that of the MPS shown in FIG. 5a, but the lower output receptacles do not include the storage cassettes 106; rather, the escrow regions 104 make up the lower output receptacles 102c-h. Thus, the overall height of the machine is reduced. Alternatively, the MPS may not include the storage cassettes 106 such that only the escrow regions make up the lower output receptacles, but the device may be equipped with legs or a base such that it is floor standing. Another table-top multiple-output-receptacle currency handling device that may be used in the second stage 14 according to one embodiment of the present invention is disclosed in U.S. Provisional Patent Application Ser. No. 60/492,104, entitled “Currency Processing Device, System and Method” and filed on Aug. 1, 2003, which is incorporated herein by reference in its entirety.

According to one embodiment of the multi-stage system 10 (FIG. 1), one function of the second currency processing stage 14 is to sort the currency bills previously processed by the first currency processing stage 12. The MPS 100 is capable of sorting bills according to denomination into each of the output receptacles 102. Using United States currency bills as an example, a stack of mixed currency bills is received in an input receptacle 108. In other embodiments of the present invention, the MPS 100 is capable of authenticating currency bills. Currency bills are transported, one at a time, from the input receptacle 108 through an evaluation region 110 by a transport mechanism 112 to the plurality of output receptacles 102a-h. In sorting the bills, the evaluation region 110 identifies the denomination of each of the currency bills and the transport mechanism delivers each bill to a particular one of the lower output receptacles 102c-h according to denomination (e.g., U.S. $1 bills into the first lower output receptacle 102c, U.S. $5 bills into the second lower output receptacle 102d, etc.), while bills triggering error signals, such as no call or suspect document error signals, are off-sorted to upper output receptacles 102a,b. Numerous other operational alternatives are available to an operator of the MPS 100. For example, the first upper output receptacle 102a can be used to receive bills triggering no call error signals and the second upper output receptacle 102b can be used to receive bills triggering suspect document error signals. Many other alternative operation modes and examples thereof are disclosed in U.S. Pat. Nos. 6,398,000 and 6,460,705, each of which is incorporated herein by reference in its entirety.

In alternative embodiments of the multi-stage system 10, the MPS 100 includes a bill facing mechanism 114, interposed in the transport mechanism 112, intermediate the bill evaluation region 110 and the lower output receptacles 102c-h that is capable of rotating a bill approximately 180° so that the face orientation of the bill is reversed. The leading edge of the bill (the wide dimension of the bill according to one embodiment) remains constant while the bill is rotated approximately 180° (about an axis parallel to the narrow dimension of the bill) so that the face orientation of the bill is reversed. Further details of the operational and mechanical aspects bill facing mechanisms for use in the MPS 100 are disclosed in U.S. Pat. Nos. 6,074,334 and 6,371,303, each of which is incorporated herein by reference in its entirety.

Referring to FIG. 5b, a MPS 150 is shown that includes an automatic bill strapping device, which is often referred to as “auto-strapping.” The MPS 150 having auto-strapping capability automatically straps (places a band around) a predetermined number of bills. For example, a machine having auto-strapping capabilities automatically strap every one hundred $20 bills. In contrast, the single-pocket devices described in connection with FIG. 2 operates pursuant to a strapping mode of operation wherein an operator manually places a strap around a stack of bills. At few as one pocket, or a many as all of the pockets of the MPS 150 can be configured with an auto-strapping device. For example, in an application wherein a large portion of the bills are $20 bills, it may be desirable to send $20 bills to a pocket that includes an auto-strapper. Generally, a device having an auto-strapper associated with only one of its pockets is less expensive than a device having auto-strapper associated with each of its pockets.

As illustrated in FIG. 5b, the MPS 150 comprises an input receptacle 152, an evaluation unit 154, and plurality of output receptacles 156a-156f, and a moving means 158 for moving currency bills from one or more of the output receptacles 152a-f to a strapping unit 160. A transport mechanism (not illustrated in FIG. 5b) is adapted to transport the bills from the input receptacle 152, past an evaluation unit 154, to the output receptacles 152a-f. According to the particular needs of an application, the evaluation unit 154 is to analyze, denominate, authenticate, count, sort, identify, and/or otherwise process the currency bills received in the input receptacle 152. After each currency bill has been evaluated, it is sent to an appropriate one of the output receptacles 152a-f.

Generally bills or other documents are transported into the various output receptacles 152a-f. When one of the output receptacles 152a-f reaches a strap limit, a controller directs the moving means 158 to move all the bills in an individual one of the output receptacles 152a-f to the strapping unit 160 and then the strapping unit 160 binds the bills together with a strap. In some embodiments the moving means 158 for moving currency bills is designed to move bills individually from an output receptacle to the strapping unit 160 wherein the bills are restacked prior to strapping. Alternatively, in some embodiments the moving means 158 is designed to move a complete stack of bills from an output receptacle 152a-f to the strapping unit 160. The moving means 158 may be coupled to some or all of the output receptacles so as to permit the movement of bills from some or all of the output receptacles 152a-f to the strapping unit 160. Any of a variety of different moving means 158 can be used to move bills to be strapped from an output receptacle 152a-f to the strapping unit 160.

The MPS 150 may also comprise one or more receptacles for receiving strapped currency. For example, an internal receptacle 162a may receive strapped currency bundles from the strapping unit 160. Alternatively, or additionally, an external strapped currency receptacle 162b may be provided for receiving currency from a strapping unit. Likewise, in some embodiments, the strapped currency receptacles 162a,b are replaced with a plurality of strapped currency receptacles. According to some embodiments, each of the plurality of strapped currency receptacles may be adapted to receive strapped currency according to the denomination of the strapped currency. For example, a $1 bill strapped currency receptacle may be provided to receive straps of only $1 bills, a $5 bill strapped currency receptacle may be provided to receive straps of only $5 bills, etc.

In some embodiments, the MPS 150 includes more than one strapping unit 160. For example, each output receptacle 152a-f may have a dedicated strapping unit 160 associated therewith. One or more or all of the strapping units 160, 160a, 160b may reside within the MPS 150, be mounted to the body of the MPS 150, or be external to the device 150.

A MPS having an auto-strapper associated with one or more pockets provides the advantage of automating the strapping process which, in turn, speeds up the overall currency handling process. A MPS having auto-strapping capabilities is described in detail in copending U.S. application Ser. No. 60/388,433, entitled “Currency Processing and Strapping System and Method for Using the Same” and filed Jun. 13, 2002, which is hereby incorporated by reference in its entirety.

Referring now to FIG. 6, there is shown an alternative embodiment of the multi-stage system 10 that includes two MPSs 100 in the second stage 14, six first stage 12 devices 18a-f, and five third stage 16 devices 24a-e. While a discrete number of devices are depicted in each of the three currency processing stages 12, 14, 16 depicted in FIG. 6, it is to be understood that any practical number of devices may be implemented at each stage 12, 14, 16 of the multi-stage system 10. According to the multi-stage system 10 illustrated in FIG. 6, each of the individual currency processing devices 18, 20, 24 of stages one 12, two 14, and three 16, are networked together and coupled to a central controller such as P.C. 90. According to one embodiment, the P.C. 90 also controls the operation of one or more of the second stage currency processing devices 20. The P.C. 90 includes memory (not shown) for storing information associated with the processing of currency with the multi-stage system 10, or is alternatively coupled to a database (not shown) storing that information. According to an alternative embodiment of the multi-stage system 10, the P.C. 90 is integrated with the one or more second stage currency processing devices 20, or is in close physical proximity to the second stage devices 20. Generally, the P.C. 90 monitors the currency received by each stage and the compares the totals determined at each stage to the totals determined at subsequent stages.

An example of the operation of one embodiment of the multi-stage system 10 shown in FIG. 6 will be now described. In one application, the multi-stage system 10 is implemented in a banking environment wherein each of the first stage 12 currency processing devices 18 are utilized by bank tellers who receive cash deposits (as well as other types of deposits) from customers of the bank. At stage one 12, the teller inputs information associated with a received cash deposit including the declared cash deposit amount (also referred to as the “declared balance”) and optionally a teller identification number, the time of deposit, the date of deposit, a customer account number, etc. using the operator interface of the first stage device 18. According to one embodiment, the information input by the teller is input utilizing the operator interface of the first stage device 18 (e.g. the operator interface 53 shown in FIG. 2, or the operator interface 85 shown in FIG. 4), or in input to another operator interface (now shown) that is coupled to the P.C. 90. Further, according to other alternative embodiments, the first stage device may not be coupled to the P.C. 90, and the teller enters the determined totals (i.e., the value of currency processed by the first stage device 18) into that teller's work station. However, networking the first stage devices 18 with the P.C. 90 adds an additional level of integrity to the overall process by reducing the chances for errors associated the tellers manually entering the determined amounts, or teller malfeasance.

In other alternative embodiments, the first stage devices 18 may be capable of reading the deposit slips filled out by a customer. In such an embodiment, the deposit slip would be placed in the input receptacle—at the head or rear of the bills to be deposited—of the first stage device 18, which would then read the declared balance from the deposit slip. Alternatively still, a customer may electronically transmit (e.g., over the Internet) or call-in the customer's declared balance. Then, the customer or the customer's representative (e.g., an employee or a courier) would bring the funds to be deposited with a print-out of the electronically transmitted deposit slip, or some other identifier, to present to the bank teller in the first stage 12.

As a teller at stage one 12 receives and processes cash deposits, the received deposit is compared to the declared balance. If the deposit and the declared balance favorably compare, the teller places the received currency into cash drawers for holding the currency. Other money holding containers can also be used to hold currency bills received by a teller in the first stage 12 according to other embodiments of the present invention. If the deposit and the declared balance do not favorably compare, the teller at the first stage may attempt to reconcile the discrepancy with the customer, reprocess the deposit, or both. As the teller receives deposits and places the currency into the cash drawer, the teller may maintain a separation between the received deposits with identification cards or another type of marker, or may combine the deposits with no segregation between the received deposits depending on the particular protocol of the bank.

At predetermined times (e.g., every hour, twice a day, etc.) or upon the occurrence of specified events (e.g., teller shift change, cash drawer being filled, receiving a deposit, receiving a predetermined number of deposits, etc.), a batch of currency processed by a teller at the first currency processing stage 12 is moved to the second currency processing stage 14 of the multi-stage system 10. A “batch” of currency transferred from stage one 12 to stage two 14 may simply consist of a filled cash drawer, or may correspond to all the currency processed during a specific time frame, by a specific teller, etc. Each batch of currency transferred from stage one 12 to stage two 14 has an associated total. Alternatively, if the distinction between the individual batches received in the first stage 12 is maintained, the cash drawer transferred to stage two 14 will have a number of sub-totals corresponding to the deposits) and a grand total corresponding to the sum of the subtotals.

At the second stage 14, according to one embodiment of the present invention, the currency received from stage one 12 is counted and sorted according to denomination. The one or more second stage devices 20 sorts the bills such that each of the output receptacles 22a-f hold a single denomination of bills. Using U.S. currency bills as an example when the second stage device 20 is the MPS 100 of FIG. 5a, U.S. $1, $5, $10, $20, $50, and $100 bills are sorted according to denomination into the lower output receptacles 102c-h: $1 bills are directed to the first lower output receptacle 102c, $5 bills are directed to the second lower output receptacle 102d, and so on. When a storage cassette 106 corresponding to one of the lower output receptacles 102c-h is filled, that storage cassette 106 is emptied or replaced with an empty storage cassette 106.

As the currency bills received from the first stage 12 are processed by the second stage, the total for the batch (e.g., in a cash drawer) transferred to the second stage 14, which was determined at the first stage 12, is verified according to one embodiment of the present invention. Put another way, the total for the transferred batch determined at the first stage 12 is compared to the total determined at the second stage 14 for accuracy. If the totals do not match, the operator can reconcile the discrepancy at that time or at a later time by, for example, reprocessing all of the batches having bills currently in the output receptacles 102c-h, by accepting the total determined by the second stage 14 as the correct total and adjusting the total determined by the first stage accordingly, and/or alerting the bank's security representative. In an alternative embodiment of the present invention, the teller at the first stage 12 may maintain each of the received deposits individually as discussed above. Then, at the second stage 14, each of the individual batch totals—each subtotal in a cash drawer transferred from the first stage 12 to the second stage 14—are verified at the second stage 14. As the storage cassettes 106 of the lower output receptacles 102c-h of the MPS 100 become filled or at certain times or upon the occurrence of certain events, the storage cassettes 106 are moved to the third stage 16 of the multi-stage system 10. Alternatively, the cassettes 106 are emptied and the currency bills processed at stage two 14 are moved to stage three 16. At stage three 16, the currency bills, which were sorted by denomination in stage two 14, are processed by the stage three 16 currency processing devices 24a-e, which may be operated pursuant to a strapping mode of operation according to one embodiment of the multi-stage system 10.

Like the currency moved from stage one 12 to stage two 14, each batch of currency moved from stage two 14 to stage three 16 has a total associated with it. For example, the stage two 14 device(s) determines the total value of bills for each of the storage cassettes. This total amount may be stored within the P.C. 90. As these batches of currency are again processed in stage three 16, the totals determined in stage two 14 are checked and verified. Alternatively, one or more of the third stage devices are capable of auto-strapping currency bills as is described above.

The third stage 16 currency processing devices 24a-e permit the setting of limits (e.g., a “strap limit”) on the number of bills transported to an output receptacle(s) of the third stage device 24. For example, it may be desirable to gather U.S. $20 bills into stacks of one hundred bills. Accordingly, if, for example, bills are being processed such that only U.S. $20 bills are being directed into an output receptacle, the device may halt after one hundred $20 bills have been delivered to the output receptacle. The display may then indicate that a strap limit has been reached for the output pocket. Various strap limits may be preset or set by the operator of the device. Alternatively, when a two-pocket device 80 (FIG. 4) is used as a third stage device 24, bills are directed to the second output receptacle 84 after the strap limit has been reached in the first output receptacle 82. In such an embodiment, the two-pocket device 80 halts after the strap limit has been reached in both output receptacles 82, 84.

Once the third stage device 24 has halted/suspended the transporting of bills to the output receptacle(s), the operator removes the stack of bills from the output receptacle and straps the bills by binding the stack of bills with a bill strap as is well known in the art. Upon receipt of input from the operator (e.g., via the operator interface 53 in FIG. 2 or operator interface 86 in FIG. 4), the third stage device 40 resumes operation transporting another predetermined number of bills to the output receptacle. In another alternative embodiment, when a two-pocket device 80 (FIG. 4) is used as a third stage device 24 and is operating pursuant to strapping mode of operation, the operator can clear/remove bills from one output receptacle “on the fly” while bills are being delivered to the other output receptacle wherein the device alternates between cleared output receptacles after a strap limited is reached in the other output receptacle. For example, if the strap limit has been reached in the first output receptacle 82 and further bills are being directed to the second output receptacle 84, the operator can remove the stack of bills from the first output receptacle 82 wherein the device 80 automatically directs bills back to the first output receptacle 82 when the strap limit is reached in the second output receptacle 84. In yet another alternative embodiment, such as when the device(s) is not operating pursuant to a strapping mode, the device continues to run until the output receptacle(s) reaches capacity (i.e., a “stacker full” condition) and then halts operation.

According to one embodiment, the third stage currency processing devices 24 are note counting devices (“note counters”) which simply count the number of bills that are transported from the input receptacle to the output receptacle. In using a note counter, an operator would designate the denomination of currency bills to be processed (e.g., U.S. $20 bills) and the device would then calculate the total value of bills evaluated. For example, if U.S. $20 were designated and the note counter device counts one hundred currency bills, the note counter device would indicate that $2000 worth of bills have been processed. Note counters are suitable for use in the third currency processing stage 16 in certain embodiments of the multistage system 19 where the currency bills have been sorted in the second currency processing stage 14, because the batches of bills processed by a the third stage devices are of a single denomination. In this embodiment, mixed batches of bills are not processed by a third stage 16 device.

In still another alternative embodiment of the present invention, devices capable of automatically strapping currency bills (e.g., the MPS 150 of FIG. 5b) are used in connection with the third currency processing stage 16. For example, one of the third stage devices 24a-e can include a MPS having an auto-strapper associated with one or more pockets. In another example, one of the third stage devices 24a-e can include a device that counts down a predetermined number of bills from a stack of bills and then straps the predetermined number of bills. In another example, the third stage 16 includes a strapping device that receives a stack of a predetermined number of bills (counted down by a single pocket device, for example) and then straps the stack inserted therein. In still other alternative embodiments of the present invention, the third stage device includes a tabletop currency processing device (e.g., similar to the single pocket device of FIG. 1) that includes auto-strapping capabilities as discussed above. In such embodiments, currency bills input to the device's input receptacle are transported past the evaluation region, which counts, denominates, and/or authenticates the bills, to the automatic bill strapping mechanism of the device. The device suspends operation upon a predetermined number of bills (e.g., 100 bills) being transported to the auto strapping and those bills are automatically strapped. The device resumes operation after the strapped bills are removed by the operator.

In other embodiments of the multi-stage system 10, including embodiments in which the second stage 14 sorts bills according to denomination, the third stage devices 24 are capable of identifying the denomination of the bills processed. Such a device is useful in correcting any mis-sorts which may have occurred in the second stage 14. According to one embodiment of the multi-stage system 10, the third stage devices are capable of operating pursuant to a “stranger” mode wherein the device 24 compares the denomination each bill to a target denomination. The target denomination is selected by an operator via an operator interface or automatically selected by the device as corresponding to the denomination of the first bill in a stack of bills placed in the input receptacle of the device 24. When the determined denomination of a bill does not match the target denomination, a “stranger” error signal is generated by the device. A stranger error signal can be handled in several different manners depending on the type of currency processing device—single-pocket or two-pocket—being used in the third stage 16. (Note that both the single-pocket 40 device and the two-pocket device 80 may both be used in both the first stage 12 and/or third stage 16 alternative embodiments of the multi-stage system 10.) According to one embodiment, the single-pocket device 40 “presents” the stranger bill in the output receptacle (i.e., stop/halt the device 40 after the stranger bill has been delivered to the output receptacle). At that time, the operator inspects the note and removes the bill from the output receptacle. Once the stranger bill is removed, the operator indicates as such via the operator interface and the device resumes operation. Conversely, the operator may determine that the bill does in fact match the target denomination which may occur when a bill is worn or dirty, for example, making it difficult for the currency processing device to identify. In such a situation, the operator instructs the machine (via the operator interface) to include the “stranger” or “no call” bill in the total and the machine resumes operation.

When a stranger error is generated in connection with processing bills with the two-pocket device 80, the two-pocket device can, for example, off-sort the stranger bill to the second output receptacle 84 (assuming that the first output receptacle 82 is the target receptacle for bills matching the target denomination), or halt operation and present the bill as discussed above in connection with the single-pocket device 40 when bills matching the target denomination are directed first output receptacle 82 until the strap limit is reached and then to the second output receptacle 84.

The operation of an embodiment of the multi-stage system 10 shown in FIG. 6 will be explained by way of another example. In this example, the multi-stage system 10 is implemented in a bank having six teller stations, each employing a single-pocket device. The six single-pocket devices 18 make the first currency processing stage 12. Throughout the day, at various times or at the expiration of predetermined time intervals, a batch of currency received by a teller in the first stage is moved to the second stage. In the present example, batches of currency bills are moved from the first stage 12 teller stations to the second currency processing stage 14 at one hour intervals.

During a one hour time period, a teller at the first teller station containing a first stage currency processing device 18 receives several deposits of currency bills totaling $2,500. Each deposit is received by the teller and is processed (e.g., denominated, counted, and/or authenticated) using the first stage device 18a. The P.C. 90 sums the deposits processed by the first stage device 18 during the one hour time period. For example, the teller at the first teller window may receive a first deposit of $1000 in currency bills, a second deposit of $50 in currency bills, and a third deposit of $333 currency bills. The P.C. 90 maintains a running total of the deposits received and processed by the teller at the first teller window such that after the third deposit is made, for example, the P.C. knows that $1383 worth of currency bills have been processed by the first stage device 18 at the first teller window. The P.C. 90 also tracks the number of received bills of each denomination according to an alternative embodiment. When a fourth deposit in the amount of $1117 is received, for example, and those bills are processed by the first stage machine 18a at the first teller window, the running total is updated to $2500 by P.C. 90. Upon the expiration of the one hour time interval, the currency processed by the first teller station in stage one 12 is moved to the second currency processing station 14. According to one embodiment of the present invention, the P.C. 90 assigns a batch number to each “batch” of currency moved from the first currency processing stage 12 to the second currency processing stage 14. According to an alternative embodiment, each first stage device 18 maintains the running total currency bills processed and then transmits that total to the P.C. 90 when a batch of currency is moved from the first stage 12 to the second stage. Alternatively still, the total relating to a batch of currency from the first stage 12 to the second stage 14 is manually maintained in a ledger. Once a batch of currency is moved from the first stage 12 (or segregated from subsequent deposits), the teller at the first teller station begins receiving deposits which will make up the next batch.

At stage two, batches of currency bills are received from stage one 12 including the batch of $2500 received from the first teller station in the example. Several batches (e.g., three or thirty) may have accumulated at the second stage. As the operator of the second stage 14 begins to process each batch of currency bills received from the first stage 12, the operator enters the batch number assigned to the batch about to be processed into an operator interface. Alternatively, each batch has an associated identification card that is read by the second stage device 20. In one embodiment of the multi-stage system 10 shown in FIG. 6, the P.C. 90 is located in close proximity to the one or more second stage currency processing devices 20a,b wherein the operator enters the batch number directly into P.C. 90. Alternatively, the operator enters the batch number into an operator interface (not shown) of the second stage device 20.

After entering the batch number, the total ($2500 in the present example) corresponding to the batch number is called up by P.C. 90. The currency of the batch is then processed by the second stage machine 20 and sorted according to denomination into the output receptacles 22a-f of the second stage device 20. The second stage machine 20 denominates and re-counts (and optionally authenticates) the currency bills in the batch and determines a total dollar amount of the processed batch. The P.C. 90 then compares the total of the batch determined at the first stage 12 with the total determined at the second stage 14. If the two totals match (i.e., the two totals both equal $2500), the operator of the second stage 14 goes on to process the next batch of currency bills received from the first stage 12. If the two totals do not match, the operator of the second stage may attempt to reconcile the discrepancy by (i) reprocessing all of the bills in the batch; (ii) in an embodiment wherein the multi-stage system 10 implements a MPS, such as the MPS 100 shown in FIG. 5a, having lower output receptacles 102c-h by reprocessing all of the bills in the storage cassettes 106, the escrow regions 104, or both; (iii) accepting the total determined at the second stage as the correct total; or (iv) reconciling the discrepancy in another manner.

After a number of batches received from the first stage 12 have been processed at the second stage 14, batches of currency bills are transferred from the second stage 14 to the third stage 16. The batches of currency bills transferred from the second 14 to third 16 stages may correspond to the currency bills in a storage cassette 106 of the second stage device 20 according to one embodiment multi-stage system 10. For example, when a storage cassettes 106 of the second stage device 20 is at or near capacity, that storage cassettes may be removed from the second stage device 20 and is replaced with an empty cassette. According to one embodiment of the multi-stage system 10, the filled storage cassettes 106 make up the individual batches of currency that are transferred from the second stage 14 to the third stage 16.

According to one embodiment of the multi-stage system, one function of the second stage device 20 is to sort currency bills according to denomination into the output receptacles. Therefore, each storage cassette 106 transferred to the third stage 16 includes currency bills of a single denomination.

According to one embodiment, as each storage cassette become filled and is removed from the second stage device, the P.C. 90 assigns a batch number to that storage cassette/batch and stores that batch number along with the associated total amount of bills in the batch/cassette. Alternatively, the batch number and associated total may be manually recorded in a ledger. In other alternative embodiments, the batch of currency bills transferred from the second stage 14 to the third stage 16 may not correspond to the bills in a cassette. Rather, bills may be removed from a cassette and moved as one or more batches from the second stage 14 to the third stage 16. The cassettes 106, however, are a convenient means for physically transporting the currency bills from the second stage 14 to the third stage 16.

At predetermined times or upon the occurrence of certain events (e.g., a storage cassette 106 becoming filled), the full or near full storage cassettes 106 are transferred from the second currency processing stage 14 to the third currency processing stage 16, which includes five single-pocket devices in the present example. According to one embodiment of the multi-stage system 10, each third stage device 24 is adapted to denominate and count bills as well as operate pursuant to a strapping mode of operation wherein the device suspends operation once a predetermined number of bills have been transported to the output receptacle of the single-pocket device.

In the present example, a filled storage cassette containing 1000 one-dollar ($1) bills, totaling $1000, is transferred to the third stage 16. According to one embodiment of the multi-stage system 10, one function of the third stage 16 is to count the bills down into stacks of one hundred (100) bills for strapping. Before processing the batch of bills received from the second stage 14 at the third stage 16, an operator in the third stage 16 enters the batch number associated with the batch/cassette of bills that the operator is about to process. According to one embodiment, the operator may enter this information directly onto an operator interface of the third stage device 24. Alternatively, the operator may enter this information into a terminal linked to the P.C. 90 and the third stage devices 24. Accordingly, when the operator enters the batch number associated with aforementioned batch/cassette filled with one thousand $1 bills, the P.C. 90 pulls up the corresponding amount, $1000. As the bills of this batch are processed with a third stage device 24, the third stage device maintains a running total of all the bills in the batch/cassette. After the entire batch/cassette of bills received from the second stage 14 has been processed by the third stage device 16, the total determined at the third stage 16 is compared with the total determined at the second stage 14 (which is associated with the batch number entered at the third stage). If the totals determined at the second 14 and third 16 stages favorably compare, the operator may move onto processing the next batch/cassette of currency bills received from the second stage 14. If the totals determined at the second 14 and third 16 stages do not favorably compare, the operator may choose to reprocess the batch of bills from the second stage received at the third stage, or otherwise reconcile the discrepancy.

As the bills of each batch received from the second stage 14 are processed at the third stage, the third stage device(s) 24 operates pursuant to a strapping mode of operation wherein a predetermined number of bills (e.g., one hundred bills) of a designated denomination are transported to the output receptacle. The designated denomination is selected by the operator of the third stage device 24 via an operator interface prior to processing the bills of a particular batch received from the second stage. After a predetermined number of bills of a designated denomination are transported to the output receptacle of the third stage device 24, the stack of bills in the output receptacle is removed and then bound with a strap according to one embodiment of the multi-stage system 10. Upon removal of the stack of bills from the output receptacle, the operator can indicate as such via the operator interface causing the device 24 to begin transporting another one hundred bills to the output receptacle. As discussed above, the third stage device also maintains a running total of the dollar amount (and/or number of bills) in each batch received from the second stage 14 that is processed in the third stage 16 for comparing the total(s) determined at the second stage 14.

As discussed above, according to one embodiment of the present invention, the third stage devices 24 may also operate according to a “stranger” mode of operation where the device 24 suspends operation when a determined denomination of a bill does not match the designated denomination. The bill whose determined denomination does not match the designed denomination, or whose denomination cannot be determined (i.e., a “no call” bill), is presented in the output receptacle. The operator of the third stage device 24 can inspect the bills and either accept the bill (indicate the bill is properly included in the stack of bills in the output receptacle) or reject the bill and remove it from the output receptacle. The operator can input to the third stage device 24 via the operator interface of the third stage device 24, whether the bill should be included in the running total and the count of the predetermined number of bills being transported to the output receptacle of the third stage device 24 for strapping purposes.

The currency bills are processed in this manner until the entire batch is processed and the total is determined at the third stage 16, which is compared to the total determined at the second stage 14 for the particular batch as discussed above. In the present example of 1000 $1 bills making up a batch that is processed at the third stage 16, 100 strapped stacks of 100 $1 bills are the result of the third stage 16 processing. When there are “left-over” bills at the end of a batch (i.e., an stack not having enough bills to be strapped), those bills may be set aside and combined with other left-over bills at the third stage 16.

The multi-stage system 10 provides the advantage of imparting additional levels of security and accuracy to the overall currency handling process. Verifying the totals at multiple levels enables users to quickly identify errors when tellers are out of balance, or if there have been any mis-counts or mis-sorts. The P.C. 90 compares the totals at each stage of the multi-stage system 10: a first comparison occurs as the P.C. compares the batch totals determined at stage one 12 are compared to the total for that batch determined at stage two 14; and a second comparison occurs as the P.C. 90 compares the batch totals determined at stage two 14 to the total for that batch determined at stage 16.

In addition to performing the comparisons as described above, the P.C. 90 can also provide detailed summaries of the processed currency bills according to various embodiments of the present invention. For example, the P.C. 90 can provide a detailed summary of all of the deposits handled by each of the tellers at stage one 12. The P.C. 90 can also provide detailed summaries of the batches of currency moved from the first stage 12 to the second stage 14, a break down of all currency processed in stage two 14 according to denomination, the total amount of currency strapped as well as all of the loose currency at stage three 16, etc. Many details of the currency processed by the multi-stage system 10 is available to a user via P.C. 90.

The multi-stage system provides bank users, casino users, and other users a stand alone system for accurately processing currency bills. According to some embodiments, the P.C. 90 is networked to a central computer system (not shown), such as a bank's central computer system, for transferring information regarding the processing of currency with the multi-stage system 10. The information may be transferred on a real-time basis, a batch basis, at predetermined times, or upon the occurrence of predetermined events. Alternatively, the devices of the three currency processing states 12, 14, 16 may by interfaced with a bank's, an armored carrier company's, or a casino's central computer system wherein the central computer system can handle the data processing otherwise handled by P.C. 90.

According to other alternative embodiments of the present invention, the currency processing devices at any of the stages 12, 14, 16 of the multi-stage system 10 can evaluate the fitness of currency bills. Currency handling devices capable of evaluating the fitness of currency bills are described in U.S. Pat. No. 6,278,795 and in U.S. patent application Publication No. 2003-0168308-A1, each of which is incorporated herein by reference in its entirety. In some applications, it is desirable to off-sort unfit bills such as limp bills, soiled bills, torn bills, or bills having tape adhered thereto, etc. Often it is undesirable to use unfit bills in bill dispensing mechanisms such as those found in ATMs. Many banks will only load ATMs with bills having a minimum degree of fitness.

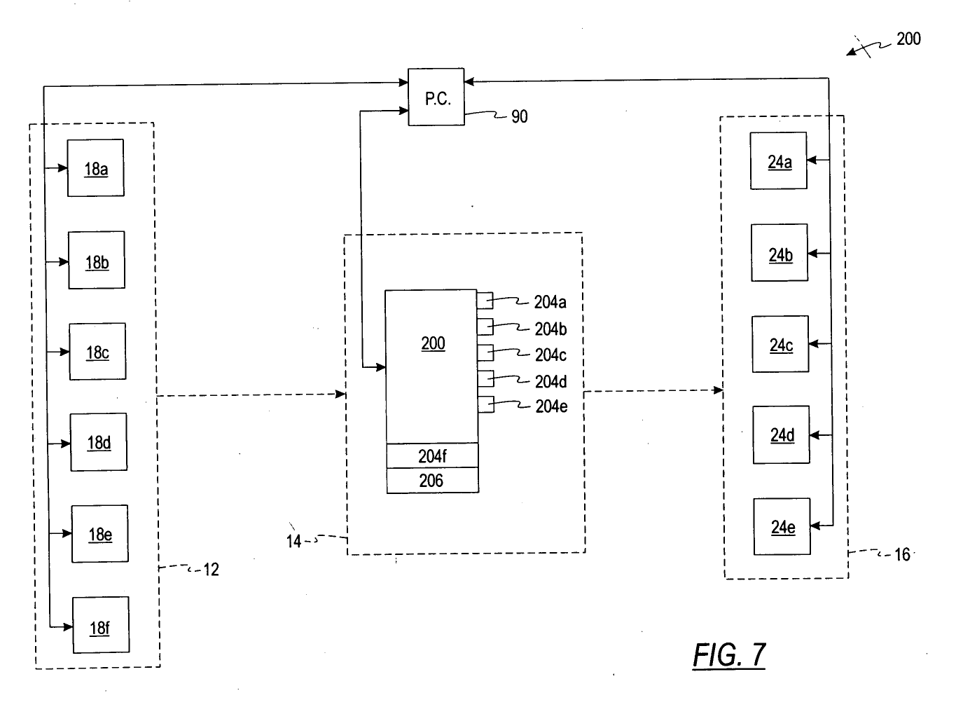

Referring to FIG. 7, an alternative embodiment of a multi-stage system 200 is shown that includes a first stage 12, second stage 14, and third stage 16 similar to the system 10 of FIGS. 1 and 6. The system 200 includes one or more second stage currency processing devices 202 having a plurality of output receptacles 204a-f wherein one of the output receptacles has an auto-strapping device 206 associated therewith. In the illustrated embodiment, the sixth output receptacle 202f has the auto-strapper 204 associated therewith. Having an auto-strapping device 206 associate with one of the output receptacles of the second stage currency processing device 200 provides the flexibility of allowing an operator to send denominations of currency bills of which there is a high volume (e.g., 40% U.S. $20 bills) to the auto-strapper pocket 204f so as to eliminate the time required for strapping those bills in the third currency processing stage 16. Those bills directed to the other output receptacles 204a-e of the second stage 14 currency processing device are transferred to the third currency processing stage 16 for processing as described above.

In an alternative embodiment of the multi-stage system 200, the second stage 14 does not include currency processing device having an auto-strapper. Rather, one or more third stage 16 currency processing devices 24a-e having auto-strapping capabilities are implemented in the multi-stage system. For example, one more MPS 150 (FIG. 5b) can make up the third stage 16 currency processing devices 24. Implementing devices having auto-strapping capabilities in the third stage 16 decreases the time required for processing and strapping the bills received from the second stage 14.

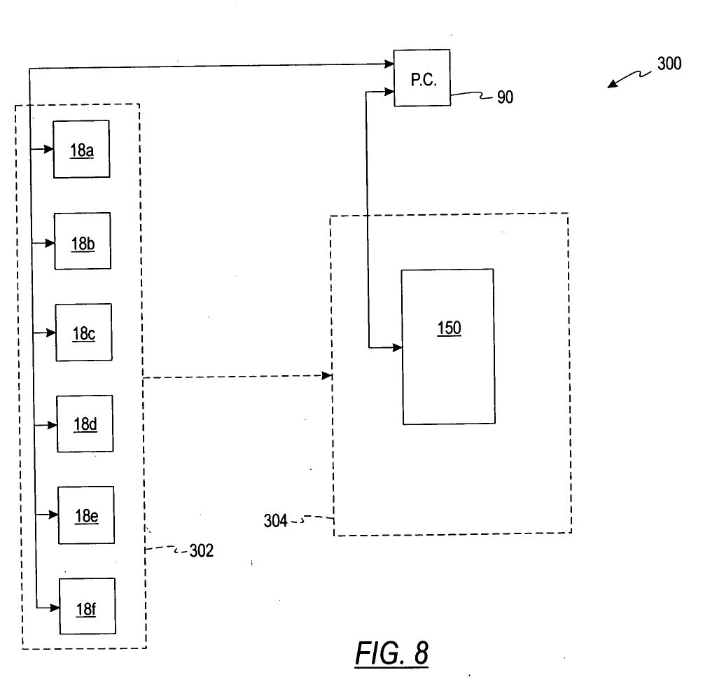

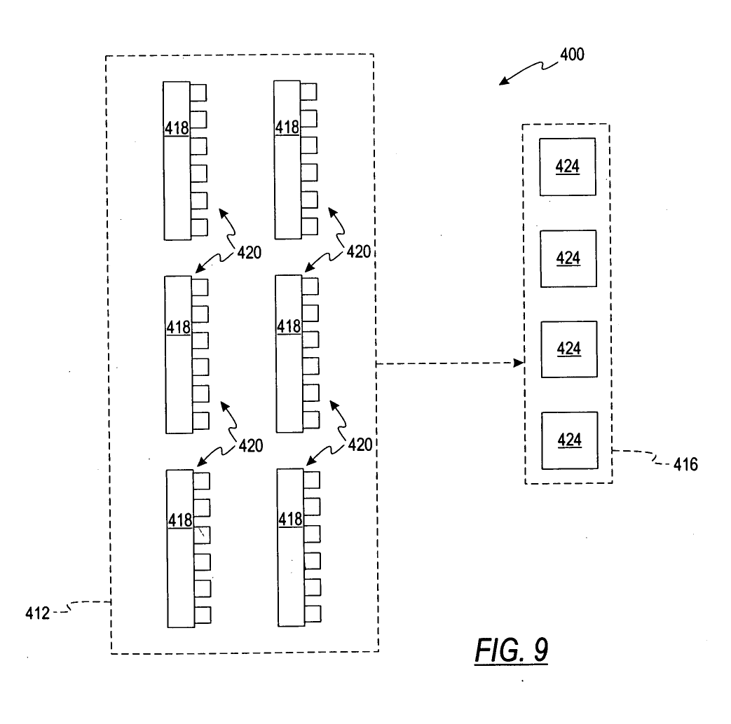

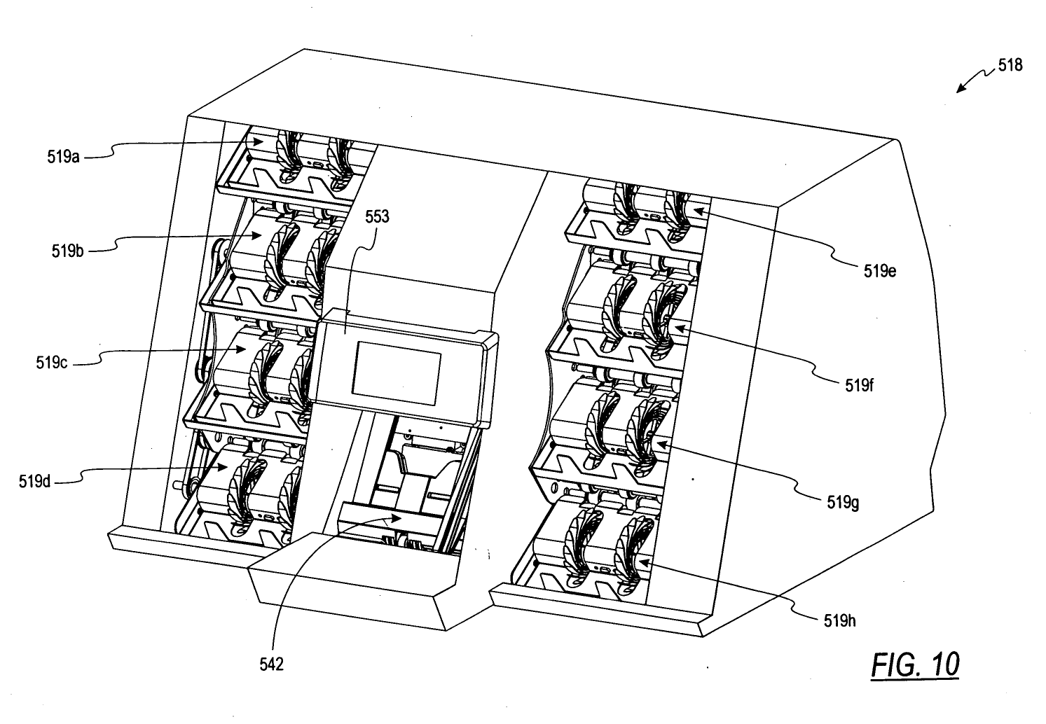

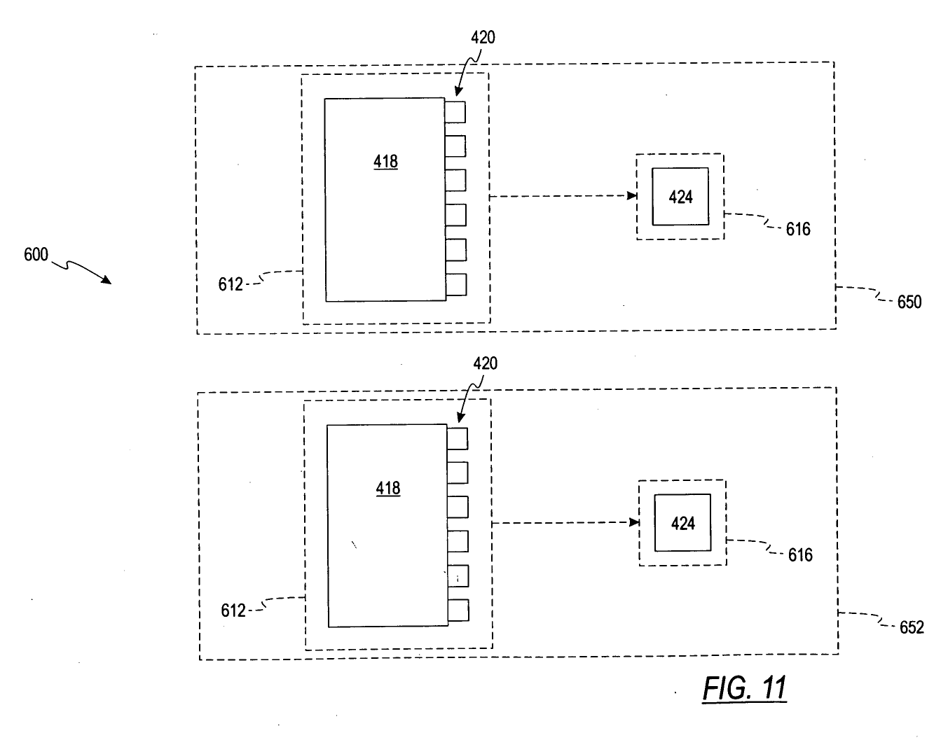

Referring to FIG. 8, an alternative embodiment of a multi-stage currency processing system 300 is shown having a first stage 302 and a second stage 304. The first stage 302 of the multi-stage system 304 is similar to the first stage 12 described in connection with FIG. 6. The second stage 304 of the multistage system includes one or more MPS devices 150 capable of auto-strapping currency bills. This embodiment decreases the time in which currency deposits received in the first stage 302 are verified and strapped by eliminating a third stage and by using an auto-strapping MPS 150 in the second stage to strap the currency bills. However, the second comparison provided by comparing totals for bills processed in a second stage to the totals for those bills proceeded in the third stage is not present in the embodiment illustrated embodiment of the multi-stage system 300 shown in FIG. 8.

Referring to FIG. 9, a two-stage currency processing system 400 including a first currency processing stage 412 and a second currency processing stage 416 is shown according to an alternative embodiment of the present invention. The first stage 412 includes a plurality of first stage currency processing devices 418 having a plurality of output receptacles 420 (e.g., three, four, six, or eight output receptacles). Each first stage device 418 is associated with a teller station, for example, when the two-stage system 400 is used in a banking environment. The second stage 416 includes a plurality of second stage currency processing devices 424.

Referring also to FIG. 10, an example of a currency processing device 518 having a plurality of output receptacles 519a-h that can be used as a first stage device 418 of the system 400 is shown according to one embodiment of the present invention. The device 518 includes an input receptacle 542 for receiving a stack of currency bills for deposit, and an operator interface 553 for communicating with the bank teller operating the device 518. The device 518 is compact and designed to be placed on a tabletop having a height of about 27 inches (about 68.6 cm), a width of about 44 inches (about 111.8 cm), and a depth of about 25.5 inches (about 64.8 cm), and weighs approximately 250 lbs. (about 113.4 kg). Thus, according to some embodiments the device 518 has a footprint of less than about 1122 in² (about 7.8 ft²) and a volume of less than about 30,300 in³ (about 17.5 ft³). Further details of the device 518 of FIG. 10, as well as other tabletop currency processing devices having multiple-output receptacles that can be used as a first stage device 418 in alternative embodiments of the present invention, are disclosed in U.S. Provisional Patent Application Ser. No. 60/492,194 (“Currency Processing Device, Method and System”), filed on Aug. 1, 2003, and is incorporated herein by reference in its entirety.

The two-stage system 400 of FIG. 9 operates in a manner similar to the system of FIG. 1 except that, because the first stage devices 418 includes a plurality of output receptacles 420, the first stage devices 418 are able to sort the currency bills received at the first stage 418. In operation, a teller receives a cash deposit and places the currency bills in the first stage device 418 at that teller's station. The first stage device 418 counts, and optionally authenticates, the received deposit and compares the determined total to the declared balance. The first stage device 418 sorts the processed currency bills by denomination into the plurality of output receptacles 420. If the declared balance and the determined total for the received deposit favorable compare, the teller moves the sorted bills from the output receptacles 420 into the teller's cash drawer, in which the separation of the bills by denomination is maintained. Alternatively, the teller may wait to move bills to a cash drawer until one of the output receptacles 420 reaches capacity. The teller maintains a record of the total amount of bills placed into the cash drawer.

At certain times or upon the occurrence of certain events, the teller's cash drawer at the first stage 412 is transferred to the second stage 416, wherein the total corresponding to the transferred cash drawer is verified and the bills are strapped in stacks of a predetermined number of bills. The second devices 424 may comprise any of the third stage devices for strapping bills as previously discussed. For example, the third stage device 424 may comprise the single pocket device 40 (FIG. 2) or the double-pocket device (FIG. 4) that operates according to a strapping mode of operation wherein a predetermined number of bills are transported to the output receptacle and an operator manually straps that stack of bills. Alternatively, a tabletop device that counts and automatically straps bills is used in alternative embodiments of the present invention. Alternatively still, a multi-pocket device having auto-strapping capabilities such as discussed in connection with FIG. 5b may be used.

Referring now to FIG. 11, an alternative embodiment of a multiple-stage currency processing system 600 is shown according to an alternative embodiment of the present invention. The system 600 includes a first currency processing stage 612 having a first stage currency processing device 418 and a second currency processing stage 616 having a second stage currency processing device 424. The system 600 operates in a manner similar to that of the system 4004 (FIG. 9) except that the first and second stages 612, 616 are both associated with, and operated by, a bank teller, or both stages occur side-by-side one another. The first stage device 418 is a tabletop currency processing device having a plurality of output receptacles 420 that is capable of sorting bills as discussed above. Alternative, the first stage device 418 may be a floor-standing device having a plurality of output receptacles. Each second stage device 424 may comprise any of the third stage devices for strapping bills as previously discussed.

In operation of the system 600, a teller receives deposits from a bank customer and uses the first stage device to determine the total amount deposited and to sort the currency bills of the received deposit according to denomination. The determined total is compared to the declared balance. Next, after processing each deposit, or as the each of the output receptacles 420 of the first stage device 418 become filled, the teller transfers the sorted bills to the second currency processing stage 616. The second stage device 424 is located in close proximity to the first stage device 418 in a work area 650 of the teller. Reference number 612 refers a work area 652 of another teller.

At the second stage 616, the currency bills are reprocessed by the second stage device 424 and the total amount transferred from the first stage 612, determined at the first stage 612, is compared to the total determined at the second stage 616. The second stage device 424 is used for strapping the currency bills either by automatically-strapping the bills or operating to a strapping mode of operation as is discussed above.

While the present invention has mainly been described in connection with operating in a banking environment, the present invention is also applicable to other high-volume-money-handing environments such as at a casino or at an armored carrier's currency processing facility. In the casino environment, for example, the “tellers” at the first currency processing stage receive deposits, each one of which is associated with a particular gaming machine (e.g., a slot machine or a video poker machine) and/or a particular gaming table on the casino's floor. Each of the deposits may have a deposit slip bearing the declared balance, or may have an identification slip bearing an identification number so that the casino teller is unaware of the declared balance of the deposit for security purposes. The multi-stage currency processing system may be linked with the casino's accounting system, so that the total determined at the first stage and the identification number is sent to the casino's accounting system, which compares the determined total and the declared balance. If there is a discrepancy, the casino's security representative is automatically notified. In the armored carrier company environment, each deposit may correspond to the amount of money picked-up and carried from a customer's cite.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

What is claimed is:

1. A multiple stage currency processing system, comprising:
a first currency processing stage including a plurality of first stage currency processing devices having at least one output receptacle, each of the first stage currency processing devices being adapted to denominate currency bills received in the first stage, the first stage being adapted to output a plurality of first batches of currency bills processed in the first stage, each first batch having an associated first total corresponding to the value of the currency bills in the respective first batch;
a second currency processing stage for receiving first batches from the first stage, the second stage including at least one second stage currency processing device having a plurality of output receptacles, the at least one second stage currency processing device being adapted to denominate currency bills and to sort currency bills into the plurality of output receptacles, the at least one second stage device adapted to determine a second total associated with each first batch processed by the at least one second stage device, the second total corresponding to the value of the currency bills in the first batch processed by the at least one second stage device, the second stage being adapted to output a plurality of second batches of currency bills processed in the second stage, each second batch having an associated third total corresponding to the value of the currency bills in the respective second batch;
a third currency processing stage for receiving the second batches from the second stage, the third stage having a plurality of third stage currency processing devices having at least one output receptacle, each third stage device being adapted to count currency bills and to suspend operation when a predetermined number of currency bills are transported to the at least one output receptacle, the third stage devices being adapted to determine a fourth total associated with each second batch processed by the third stage devices, each fourth total corresponding to the value of the currency bills in the respective second batch processed by third stage devices; and
a central processing unit interfaced with each of the first, second, and third stage currency processing devices, the central processing unit adapted to receive information from each of the first, second, and third stage currency processing devices, the central processing unit being adapted to compare first totals to second totals, the central processing unit being adapted to compare third totals to fourth totals.

2. The system of claim 1 wherein each of the first stage devices includes an operator interface adapted to receive information from an operator of the first stage device.

3. The system of claim 1 wherein the central processing unit is adapted to control the operation of the at least one second stage currency processing device, the operator interface being adapted to receive information from an operator of the second stage currency processing device.

4. The system of claim 1 wherein each of the third stage devices includes an operator interface adapted to receive information from an operator of the third stage device.

5. The system of claim 1 wherein each second batch corresponds to the currency contained in a storage cassette associated with one of the plurality of the output receptacles of the second stage device.

6. The system of claim 1 wherein the controller is adapted to record the operator associated with the processing of each first batch.

7. The system of claim 1 wherein the controller is adapted to record the first stage device associated with the processing of each first batch.

8. The system of claim 1 wherein each first batch corresponds to all of the currency processed by a particular first stage device during a specific time period.

9. The system of claim 8 wherein the time period is one day.

10. The system of claim 8 wherein the time period corresponds to a work shift of an operator of a particular first stage device.

11. The system of claim 1 wherein a first batch corresponds to all of the currency deposited by a specific customer.

12. The system of claim 1 wherein the central processing unit is adapted to generate an error signal when a second total does not favorably compare to a first total.

13. The system of claim 1 wherein the central processing unit is adapted to generate an error signal when a third total does not favorably compare to a fourth total.

14. The system of claim 1 wherein the at least one second stage currency processing device sorts currency bills according to denomination.

15. The system of claim 1 wherein the plurality of the third stage devices are adapted to determine the denomination of the currency bills.

16. The system of claim 15 wherein each of the plurality of third stage devices includes an operator interface adapted to receive input from an operator specifying a currency denomination to be processed.

17. The system of claim 16 wherein each of the plurality of third stage devices are adapted to generate a stranger error signal when a determined denomination of a currency bill does not match the specified denomination.

18. The system of claim 16 wherein the third stage devices have two output receptacles, each of the third stage devices being adapted to suspend operation upon generation of a stranger error signal.

19. The system of claim 16 wherein the third stage devices have a single output receptacle, each of the third stage devices being adapted to suspend operation upon generation of a stranger error signal.

20. The system of claim 1 wherein at least one of the plurality of first stage devices has two output receptacles.

21. The system of claim 1 wherein at least one of the plurality of first stage devices has a single output receptacle.

22. The system of claim 1 wherein at least one of the plurality of the first stage devices is adapted to evaluate the authenticity of currency bills.

23. The system of claim 1 wherein the at least one second stage device is adapted to evaluate the authenticity of currency bills.

24. The system of claim 1 wherein at least one of the plurality of third stage devices is adapted to evaluate the authenticity of currency bills.

25. A method for processing currency bills with a multiple-stage currency processing system comprising a first stage including a plurality of first stage currency processing devices having at least one output receptacle, a second currency processing stage including at least one currency processing device having a plurality of output receptacles, and a third currency processing stage including a plurality of currency processing devices having at least one output receptacle, the method comprising:
receiving currency bills to be processed in the first currency processing stage;
denominating the received currency bills with one or more of the first stage devices;
grouping currency bills denominated by the one or more first stage devices into a plurality of first batches, each first batch having an associated first total corresponding to the value of currency bills in the first batch;
receiving one or more of the first batches from the first currency processing stage in the second currency processing stage;
denominating the currency bills of each received first batch with the at least one second stage currency processing device;
determining a second total for each received first batch with the at least one second stage currency processing device, the second total corresponding to the value of the currency bills in the first batch;
comparing the first total to the second total;
sorting currency bills of each received first batch with the at least one second stage currency processing device into a plurality of second batches, each second batch having an associated third total corresponding to the value of currency bills in the second batch,
receiving one or more second batches in the third currency processing stage;
counting the currency bills of each received second batch with one or more of the plurality of third stage currency processing devices;
determining a fourth total for each received second batch with the one or more third stage currency processing devices, the fourth total corresponding to the value of the currency bills in the second batch; and
comparing the third total to the fourth total.

26. The method of claim 25 further comprising receiving information from an operator of a first stage currency processing device via an operator interface.

27. The method of claim 26 wherein the information is selected from the group consisting of a customer account number, a customer name, date, time, and a declared deposit amount.

28. The method of claim 25 further comprising interfacing each of the plurality of first stage currency processing devices, the at least one second stage currency processing device, and each of the plurality of third stage currency processing devices with a central processing unit.

29. The method of claim 28 wherein the central processing unit is adapted to receive information from each of the plurality of first stage currency processing devices, the at least one second stage currency processing device, and each of the plurality of third stage currency processing devices.

30. The method of claim 25 wherein the plurality of second batches correspond to the plurality of output receptacles of the at least one second stage currency processing device.

31. The method of claim 25 wherein sorting further comprises sorting according to denomination.

32. The method of claim 25 wherein grouping further comprises grouping according to a predetermined criteria selected from the group consisting of an operator of the first stage currency processing devices, a specific first stage device, currency processed by a first stage device during a specific time period, and customer identification.

33. The method of claim 25 further comprising generating an error signal when a second total does not favorably compare to a first total.

34. The method of claim 25 further comprising generating an error signal when a third total does not favorably compare to a fourth total.

35. The method of claim 25 wherein counting the bills further comprises determining the denomination of each of the currency bills with the one or more of the plurality of third stage currency processing devices.

36. The method of claim 25 further comprising receiving input from an operator of the one or more third stage currency processing devices via an operator interface specifying a currency denomination to be processed.

37. The method of claim 36 wherein the one or more third stage devices are adapted to generate a stranger error signal when a determined denomination of a currency bill does not match the specified denomination.

38. The method of claim 37 wherein the one or more third stage device has two output receptacles, the one or more third stage device being adapted to suspend operation upon generation of the stranger error signal.

39. The method of claim 37 wherein the one or more third stage device has two output receptacles, the one or more third stage device being adapted to off-sort the currency bill triggering the stranger error signal.

40. The method of claim 37 wherein the one or more third stage device has a single output receptacle, the one or more third stage device being adapted to suspend operation upon generation of the stranger error signal.

41. The method of claim 25 wherein at least one of the plurality of first stage devices has two output receptacles.

42. The method of claim 25 wherein at least one of the plurality of first stage devices has a single output receptacle.

43. The method of claim 25 further comprising evaluating the authenticity of the currency bills with one or more of the first stage currency processing devices.

44. The method of claim 25 further comprising evaluating the authenticity of the currency bills of each received first batch with the at least one second stage currency processing device.

45. The method of claim 25 further comprising evaluating the authenticity of the currency bills of each received second batch with one or more of the plurality of third stage currency processing devices.

46. A currency processing system having three stages, comprising:
a first stage including a plurality of compact currency handling devices adapted to denominate and count currency bills, the compact devices having an input receptacle and at least one output receptacle;
a second stage including a high-capacity currency handling device adapted to denominate, count, and sort currency bills, the high-capacity device having multiple output receptacles;
a third stage including a plurality of compact currency handling devices adapted to count currency bills, the compact devices having an input receptacle and at least one output receptacle; and
a controller operatively coupled with the first, second, and third stages, the controller adapted to receive and to compare information related to the counting of currency bills at each stage.

47. The system of claim 46 wherein the controller comprises a personal computer adapted to control the operation of the high-capacity device of the second stage.

48. The system of claim 46 wherein each of the compact devices of the first stage includes an operator interface adapted to receive input from an operator of a compact device of the first stage.

49. The system of claim 48 wherein the operator interface includes a ten key numeric keypad.

50. The system of claim 46 wherein one or more of the compact devices of the first stage has a single output receptacle.

51. The system of claim 46 wherein one or more of the compact devices of the first stage has two output receptacles.

52. The system of claim 46 wherein one or more of the compact devices of the first stage, the high-capacity device of the second stage, and the compact devices of the third stage is adapted to evaluate the authenticity of currency bills.

53. The system of claim 46 wherein one or more of the compact devices of the first stage, the high-capacity device of the second stage, and the compact devices of the third stage is adapted to discriminate between fit and unfit currency bills according to a predetermined criteria.

54. A method for processing currency bills with a multi-stage currency processing system having a first, second, and third stage, the method comprising:
receiving one or more deposits including currency bills at the first stage;
denominating and counting the received currency bills using at least one compact currency handling device at the first stage;
receiving currency bills denominated and counted in the first stage at the second stage;
denominating, counting, and sorting the currency bills received at the second stage using a high-capacity currency handling device;
receiving currency bills denominated, counted, and sorted in the second stage at the third stage;
counting the currency bills received at the third stage using a compact currency handling device; and
comparing information related to the counting of currency at each of the first, second, and third stages with a controller interfaced with each of the at least one compact currency handling device of the first stage, the high-capacity currency handling device of the second stage, and the at least one compact currency handling device of the third stage.

55. The method of claim 54 wherein said controller comprises a personal computer adapted to control the operation of the high-capacity currency handling device of the second stage.

56. The method of claim 54 further comprising authenticating currency bills with one or more of the at least one compact currency handling device of the first stage, the high-capacity currency handling device of the second stage, and the at least one compact currency handling device of the third stage.

57. The method of claim 54 wherein the at least one compact currency handling device of the first stage includes an operator interface, the method further comprising receiving input, at the first stage, indicative of an account number, a declared balance, the date, and at least one additional data entry field.

58. The method of claim 57 wherein the at least one additional data entry field includes at least one of a checks total data entry field, a credit card total data entry field, or at least one other total data entry field.

59. The method of claim 54 wherein comparing further comprises comparing a first count of the one of more deposits of currency bills received at the first stage determined at the first stage to a second count of the one or more deposits of currency bills received at the second determined at the second stage.

60. The method of claim 54 wherein sorting the currency bills received at the second stage further comprises sorting received currency bills by denomination.

61. The method of claim 60 wherein sorting further compressing transporting the currency bills to a plurality of storage cassettes associated with the plurality of output receptacles of the high-capacity currency handling device, each of the plurality of output receptacles corresponding to a specific one of a plurality of denominations of currency bills.

62. The method of claim 60 further comprising:
transferring currency bills sorted by denomination at the second stage to the third stage; and
verifying the count of the currency bills obtained at the second stage with the compact currency handling device of the third stage.

63. The method of claim 62 further comprising at the third stage, following the verifying at the third stage, strapping groups of a predetermined number of currency bills.

64. The method of claim 54 further comprising comparing currency totals for each of the first, second, and third stages.

65. The method of claim 54 further comprising, at the first stage, summarizing deposit totals into one or more of day totals, shift totals, customer totals, teller totals, and batch totals.

66. The method of claim 54 wherein each of the one or more compact currency handling devices of the first stage is associated with a teller station at a bank.

67. The method of claim 66 further comprising summarizing the total amount of currency processed by each teller station with the controller.

68. The method of claim 54 further comprising maintaining a detailed summary of subtotals of currency delivered from the first stage to the second stage.

69. The method of claim 54 further comprising:
determining the total values of currency processed by denomination at the second stage; and
sending the total values of currency processed by denomination at the second stage to the controller.

70. A multiple-stage currency processing system, comprising:
a first currency processing stage for receiving account deposits including currency bills, the first stage including a plurality of first stage currency processing devices each being adapted to denominate currency bills, each first stage device being adapted to output a first batch of currency bills, each first batch having an associated first total corresponding to the value of the currency bills in the respective first batch;
a second currency processing stage for receiving first batches from the first stage, the second stage including at least one second stage currency processing device having a plurality of output receptacles, the at least one second stage currency processing device being adapted to denominate currency bills and to sort currency bills of the received first batches into a plurality of second batches, the at least one second stage device adapted to determine a second total associated with each first batch processed by the at least one second stage device, the second total corresponding to the value of the currency bills in the first batch processed by the at least one second stage device, each second batch having an associated third total corresponding to the value of the currency bills in the respective second batch;
a third currency processing stage for receiving the second batches from the second stage, the third stage having a plurality of third stage currency processing devices being adapted to count currency bills of the received second batches, the third stage devices being adapted to determine a fourth total associated with each second batch processed by the third stage devices, each fourth total corresponding to the value of the currency bills in the respective second batch processed by third stage devices; and
a central processing unit communicatively linked to each of the first, second, and third stage currency processing devices, the central processing unit being adapted to compare the first totals to the second totals and to compare the third totals to the fourth totals.

71. A method for processing currency bills with a multiple-stage currency processing system comprising a first stage including a plurality of first stage currency processing devices having at least one output receptacle, a second currency processing stage including at least one currency processing device having a plurality of output receptacles, and a third currency processing stage including a plurality of currency processing devices having at least one output receptacle, the first stage devices, the second stage devices, and the third stage devices being communicatively liked to a central computer, the method comprising:
receiving deposits including currency bills to be processed in the first currency processing stage;
denominating the received currency bills with one or more of the first stage devices;
determining the value of the currency bills in each received deposit, each deposit having an associated first total corresponding to the value of currency bills in the deposit;
assigning a first batch number to each deposit;
transmitting, to the central computer, the first batch number and corresponding first total for each deposit received in the first stage;
receiving one or more deposits from the first currency processing stage in the second currency processing stage;
entering the first batch number for each deposit into an operator interface communicatively linked to the central computer;
denominating the currency bills of each received first batch with the at least one second stage currency processing device;
determining a second total for each deposit received in the second stage with the at least one second stage currency processing device, the second total corresponding to the value of the currency bills in the deposit;
comparing the first total to the second total;
sorting currency bills of each deposit received from the first stage with the at least one second stage currency processing device into a plurality of batches, each batch having an associated third total corresponding to the value of currency bills in the batch,
assigning a second batch number to each batch;
transmitting, to the central computer, the second batch number and corresponding third total for each batch;
receiving one or more batches in the third currency processing stage;
entering the second batch number for each deposit into an operator interface communicatively linked to a central computer;
counting the currency bills of each received batch with one or more of the plurality of third stage currency processing devices;
determining a fourth total for each received second batch with the one or more third stage currency processing devices, the fourth total corresponding to the value of the currency bills in the second batch; and
comparing the third total to the fourth total.

72. The method of claim 70 wherein transmitting further comprises transmitting information selected from the group comprising data indicative of an operator of one of the plurality of first stage devices, data indicative of the time a deposit is received by the first currency processing stage, data indicative of the date a deposit is received by the first currency processing stage, data indicative of the particular one of the first stage devices that processes a received deposit, data indicative of an account number of a customer making a deposit, and data indicative of the identity of a customer making a deposit.

73. The method of claim 70 wherein counting the currency bills of each received batch with one or more of the plurality of third stage currency processing devices further comprises suspending operation of the third stage device after a predetermined number of currency bills have been transported to an output receptacle of the third stage device.

74. The method of claim 72 further comprising resuming operation upon receipt of operator input.

75. A multiple-stage currency processing system, comprising:
a first currency processing stage for receiving customer deposits including currency bills, the first currency processing stage including a plurality of first stage currency processing devices each being adapted to denominate currency bills, the first currency processing stage being adapted output a plurality of first batches of currency bills, each of the first batches corresponding to the currency bills processed by an operator of the first currency processing stage during a predetermined time period, each first batch having an associated first total corresponding to the value of the currency bills in the respective first batch;
a second currency processing stage for receiving first batches from the first stage, the second stage including at least one second stage currency processing device having a plurality of output receptacles, the at least one second stage currency processing device being adapted to denominate currency bills and to sort currency bills of the received first batches into a plurality of second batches, the at least one second stage device adapted to determine a second total associated with each first batch processed by the at least one second stage device, the second total corresponding to the value of the currency bills in the first batch processed by the at least one second stage device, each second batch having an associated third total corresponding to the value of the currency bills in the respective second batch;
a third currency processing stage for receiving the second batches from the second stage, the third stage having a plurality of third stage currency processing devices being adapted to count currency bills of the received second batches, the third stage devices being adapted to determine a fourth total associated with each second batch processed by the third stage devices, each fourth total corresponding to the value of the currency bills in the respective second batch processed by third stage devices; and
a central processing unit communicatively linked to each of the first, second and third stage currency processing devices, the central processing unit being adapted to compare first totals to second totals, the central processing unit being adapted to compare third totals to fourth totals.

76. The currency processing system of claim 74 wherein the predetermined time period is selected from the group comprising one day, one hour, a half day, a teller shift, and half a teller shift.

77. The currency processing system of claim 75 wherein each of the third stage devices is adapted to suspend operation after a predetermined number of currency bills have been transported to an output receptacle of the third stage device, the third stage device being adapted to resume operation upon receipt of input from an operator of the third stage device.
